(19) United States
(12) Patent Application Publication
(10) Pub. No.: US 2023/0008257 A1
(43) Pub. Date: Jan. 12, 2023

(54) APPLYING SAUCE DESIGNS TO FOOD

(71) Applicant: Mezli, Inc., San Mateo, CA (US)

(72) Inventors: Maxwell Emerald Perham, Palo Alto, CA (US); Alexander Makris Gruebele, Menlo Park, CA (US); Yuri Alexandrovich Kolchinski, San Francisco, CA (US)

(21) Appl. No.: 17/848,331

(22) Filed: Jun. 23, 2022

Related U.S. Application Data
(60) Provisional application No. 63/219,603, filed on Jul. 8, 2021.

(51) Int. Cl. A23P 20/15; A23L 23/00; G07F 13/00

(52) U.S. Cl. CPC A23P 20/15; A23L 23/00; G07F 13/00; A23V 2002/00

(57) ABSTRACT

A food preparation unit receives unit input in the form of an image selected by a user of a vending machine or client device application. The food preparation unit translates the image into a format that is recognizable by further components of the unit. The food preparation unit represents the image as a set of instructions for the components of the unit. The instructions comprise a selection of sauces to dispense, a dispensing method, and a dispensing nozzle. The food preparation unit identifies a starting location of the dispensing nozzle and dispenses the selected sauce from the dispensing nozzle in the form of the chosen image.

### CROSS REFERENCE TO RELATED APPLICATIONS

This application claims a benefit of U.S. Provisional Application No. 63/219,603 filed on Jul. 8, 2021, which is incorporated by reference in its entirety.

### TECHNICAL FIELD

The disclosed embodiments generally relate to automated food preparation, and particularly to automated sauce dispensing mechanisms.

### BACKGROUND

Automated food preparation systems allow for users to order and receive food such as by a vending machine with little to no necessary human interaction. Automated food preparation may allow for increased convenience for customers as well as lower costs for providers. However, because automated food preparation systems may lack human interaction between the customer and provider, there are few options for order customization within these systems. The customer may be restricted to ordering from a menu of set, prepackaged items that cannot be altered by the system which makes automated food preparation an unattractive option for customers with customization needs such as dietary restrictions and flavor preferences.

### SUMMARY

The enclosed system and method comprise a sauce dispensing mechanism that may be part of an automated food preparation system. The automated food preparation system prepares hot, customized meals based on user input. The sauce dispensing unit of the food preparation system takes further user input of an image (e.g., a logo, design, or drawing) and dispenses sauces onto the prepared food in the form of the input image.

The sauce dispensing unit includes sauce holding cartridges, pumps, tubing through which the sauce is moved, a dispensing head, dispensing nozzles, motors, a frame, and a refrigeration unit. Several embodiments of the components of the sauce dispensing unit are described with reference to the figures. In some embodiments, the sauce dispensing unit may have its own controller configured to receive user inputs and execute program code to process them to create dispensing instructions. The controller receiving user input may also be external to the sauce dispensing unit and hosted by the food preparation system such that the sauce dispensing unit receives pre-processed instructions from the food preparation system.

In one embodiment, the sauce dispensing unit receives an image from a user via an application on a vending machine or external client device (e.g., a mobile device). The image may be uploaded in several formats, so once it is received the controller translates the image to the preferred format of the sauce dispensing unit. The controller then identifies a 2D or 3D representation of the image such as by simplifying the image to have a level of detail conducive to representation in sauce. The controller then represents the image as instructions for the sauce dispensing unit. These instructions may consist of coordinates at which to draw, what sauce to use, how much pressure to pump, and what direction to move in. The sauce dispensing unit receives the instructions and identifies a location on a food surface to start dispensing. The sauce is dispensed in the form of the image, based on the instructions, using one or more sauces and dispensing nozzles. The sauce dispensing unit may then clean the dispensing nozzles to prevent cross contamination between orders (e.g., between separate food that contacts the dispensing nozzles) and prevent dripping or coagulation of sauces.

The features and advantages described in this summary and the following detailed description may not be all-inclusive. Many additional features and advantages may be apparent to one of ordinary skill in the art in view of the drawings, specification, and claims hereof.

### BRIEF DESCRIPTION OF THE DRAWINGS

FIG. 1 is block diagram illustrating an example system environment in accordance with one or more embodiments.

FIG. 2 is a block diagram illustrating the system architecture of a food preparation unit in accordance with one or more embodiments.

FIG. 3 is a flowchart illustrating a method of dispensing a sauce design onto food in accordance with one or more embodiments.

FIG. 4 is an illustration of a bowl of food before and after the dispensing of a sauce design onto it in accordance with one or more embodiments.

FIG. 5 is an illustration of a food dispensing unit of a food preparation unit in accordance with one or more embodiments.

FIG. 6 is an illustration of a sauce dispensing unit in accordance with one or more embodiments.

FIG. 7 is an illustration of a dispensing head and sauce cartridge in accordance with one or more embodiments.

FIG. 8 is an illustration of a rigid splash guard on the dispensing head in accordance with one or more embodiments.

FIG. 9 is an illustration of a flexible splash guard on the dispensing head in accordance with one or more embodiments and several embodiments of attachment methods of a splash guard to the sauce dispensing unit.

FIG. 10 is an illustration of several embodiments of dispensing nozzles and pumps.

FIG. 11 is a block diagram illustrating an example architecture of a computing device, in accordance with some embodiments.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

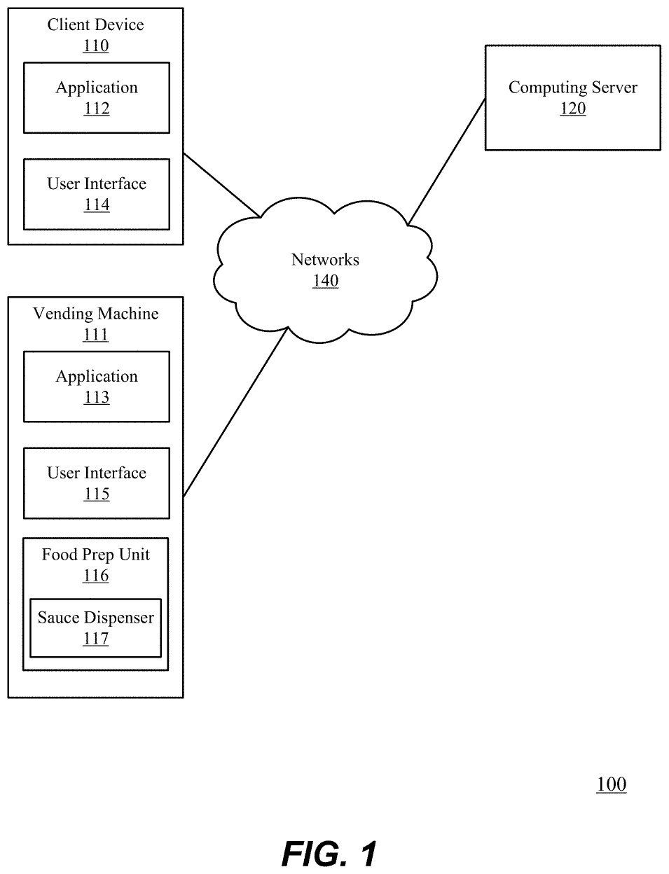

FIG. 1 is block diagram illustrating an example system environment, in accordance with some embodiments. In some embodiments, the system 100 may include one or more client devices, a computing server 120, and networks 140. A client device 110 may take the form of a computing device, such as a personal computer, a smartphone, a wearable device (e.g., smartwatch or fitness band), etc. In various embodiments, the system 100 includes fewer or additional components that are not shown in FIG. 1. The components in the system 100 are configured to communicate through the network 140.

While some of the components in the system environment 100 may be described in a singular form while other components may be described in a plural form, the system environment 100 may include one or more of each of the components. For simplicity, multiple instances of a type of entity or component in the system environment 100 may be referred to in a singular form even though the system may include one or more such entities or components. For example, in some embodiments, while the client device 110 is sometimes described in a singular form, the computing server 120 may be a service provider that serves multiple client devices 110 simultaneously. Conversely, a component described in the plural form does not necessarily imply that more than one copy of the component is always needed in the environment 100.

A client device 110 is controlled by a client of the server 120 that inputs various information such as profile information, user preferences, and dietary restrictions. The client device 110 may be referred to as a user device or an end user device herein. Each client device 110 includes one or more applications 112 and one or more user interfaces 114. The client devices 110 may be any computing devices. Examples of such client devices 110 include personal computers (PC), desktop computers, laptop computers, tablets (e.g., iPads), smartphones, wearable electronic devices such as smartwatches, or any other suitable electronic devices. The client device 110, server 120, and vending machine 111 transmit information through the network 140.

The application 112 is configured to allow users of the client device 110 hosting application 112 to order and customize food from the vending machine 111. The application 112 includes a menu displaying food options that can be prepared by a food preparation unit 116 of the vending machine 111. The application 112 communicates with the computing server 120 via the network 140. The application 112 may receive various inputs from a user or users of the client device 110 including a choice of food items, sauces to put on the food items, and an image in which the sauce is dispensed. The application provides a variety of images stored in the server 120 for display on the client device 110 such that a user can select a displayed image for their saucing preference. If the user does not choose a provided image, the application may provide an interface in which the user can draw their own image or design for the sauce to be dispensed in. The application processes user input into instructions for a controller of the vending machine 111, but that processing may also occur at the vending machine 111.

In various embodiments and depending on the type of client device 110, the application 112 may take different forms. In one embodiment, the application 112 is a web application or a mobile application. In one embodiment, an application 112 is a web application that runs on JavaScript or other alternatives, such as TypeScript, etc. In the case of a web application, the application 112 may cooperate with a web browser, which is an example of user interface 114, to render the visual elements and interactive fields of the application 112. In another case, an application 112 is a mobile application. For example, the mobile application runs on Swift for iOS and other APPLE operating systems or on Java or another suitable language for ANDROID systems. In yet another case, an application 112 is a software program that operates on a desktop operating system such as LINUX, MICROSOFT WINDOWS, MAC OS, or CHROME OS.

Application 113 of the vending machine 111 may comprise all of the functional capabilities of application 112 of the client device 110. Applications 112/113 can receive user input of food item selections, images for sauce dispensing, and more. Both applications 112/113 are updated by the server 120 such that they can display the same information. Application 112 of the client device 110 allows users of the client device 110 to order specified food items with sauce customizations from the vending machine 111 remotely and then pick up their meal at a later time. Application 113 allows a user of the vending machine 111 to order at the vending machine 111 using interface 115. The client device 110 communicates orders to the vending machine 111 while the vending machine 111 may also receive orders locally.

In one embodiment, the computing server 120 manages and provides the application 112/113. For example, the company operating the computing server 120 may be a cloud service provider that provides a front-end software application that can be installed, run, or displayed at a client device 110 or vending machine 111. For example, the company provides the applications 112/113 as a form of software as a service (SaaS). In one case, an example application 112/113 is published and made available by the company operating the computing server 120 at an application store (e.g., App store) of a mobile operating system.

The user interfaces 114 and 115 may be any suitable interfaces for receiving inputs from users and for communication with users. In one embodiment, the user interface 114/115 is a web browser such as CHROME, FIREFOX, SAFARI, INTERNET EXPLORER, EDGE, etc. and the application 112 is a web application that is run by the web browser. In another application, the user interface 114/115 is part of the application 112/113. For example, the user interface 114/115 is the front-end component of a mobile application or a desktop application. The user interface 114/115 also may be referred to as a graphical user interface (GUI) which includes graphical elements to display various elements of the application 112/113. In another embodiment, the user interface 114/115 may not include graphical elements but communicates with the computing server 120 via other suitable ways such as application program interfaces (APIs).

User interfaces 114/115 include visual displays of a menu of food items for selection as well as images of the food items on the menu. In one embodiment, a user may scroll through the menus to see different options. Once a user has chosen their food, such as by touching a portion of a screen of the user interface 114/115 displaying their food choice, they may choose the types of sauces from a sauce menu such as by checking boxes displayed in the interface 114/115. The user interface 114/115 then displays an option for the user to choose an image to draw on their food with the chosen sauces and displays a library of possible images or an easel-like interface for drawing a design. Images may also be uploaded to the client device 110 or vending machine 111 through an external device. The user interface 114/115 may be similar or nearly the same on the client device 110 and the vending machine 111 with differing sizing and scaling across devices.

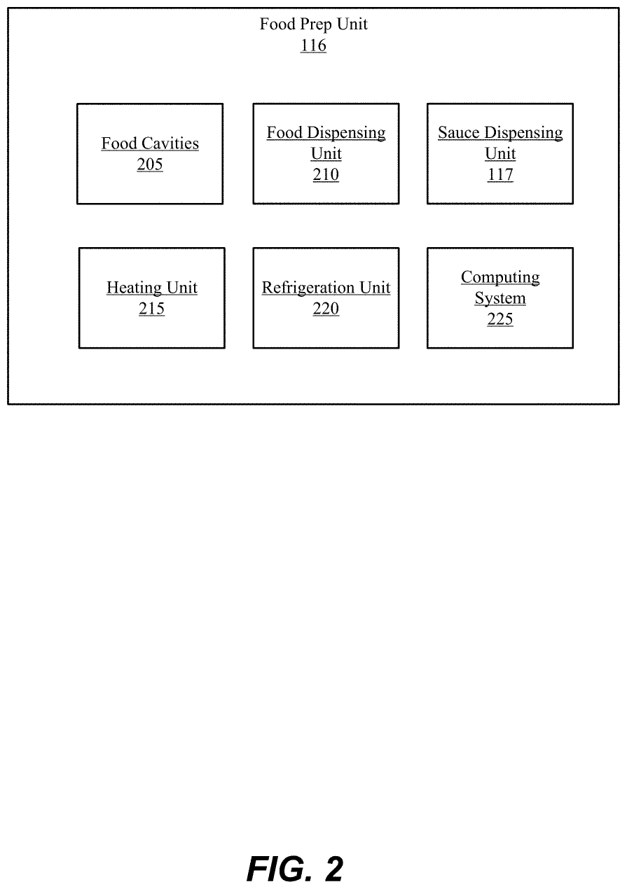

The food preparation unit 116 (also referred to as the food prep unit) prepares and dispenses food based on user input. In one embodiment the food prep 116 unit is a part of the vending machine 111. In another embodiment the food prep unit 116 is external to the vending machine 111 and communicates with it wirelessly through a network 140. The food prep unit receives pre-processed information in the form of instructions from the application 113, the instructions describing actuation mechanisms for dispensing the food chosen via the user interface 115. The food preparation unit 116 includes compartments of pre-portioned food items separated by type (e.g., separate compartments for servings of rice, servings of chicken, etc.). In another embodiment the compartments may have bulk inventory of food items and be equipped with a portioning mechanism that is activated for each order. The food prep unit 116 has a mechanism for serving food items into a bowl or plate. In one embodiment the mechanism includes a motor that causes an arm to press on a flexible wall of a food compartment to push its contents out and into a bowl below. The food prep unit 116 is further described below with reference to FIG. 2.

The sauce dispenser 117 (also referred to as sauce dispensing unit) dispenses sauce in the form of a chosen image or design based on user input to the client device 110 or vending machine 111. In one embodiment the sauce dispenser 117 is housed within the vending machine 111 with the food prep unit 116. In other embodiments, the vending machine 111, food prep unit 116, and sauce dispenser 117 are housed separately and communicate information wirelessly through the network 140. The sauce dispenser 117 includes sauce cartridges that are removably attached to a frame with tubing connected from the sauce cartridges to a dispensing head that supports dispensing nozzles. The dispensing head is moved by a motor along the frame to dispense a sauce in a chosen image as a pump moves sauce from the cartridges to the dispensing nozzle through tubing. The sauce dispenser's method and mechanisms are further described below.

The computing server 120 is one or more computing devices that process inputs from users and generate various results. In this disclosure, the computing servers 120 may collectively and singularly be referred to as a computing server 120, even though the computing server 120 may include more than one computing device. For example, the computing server 120 is a pool of computing devices located at the same geographical location (e.g., a server room) or distributed geographically (e.g., cloud computing, distributed computing, or in a virtual server network). In some embodiments, the entity operating the computing server 120 may be the publisher of the application 112/113, which communicates with the computing server 120 to download various data generated by the computing server 120.

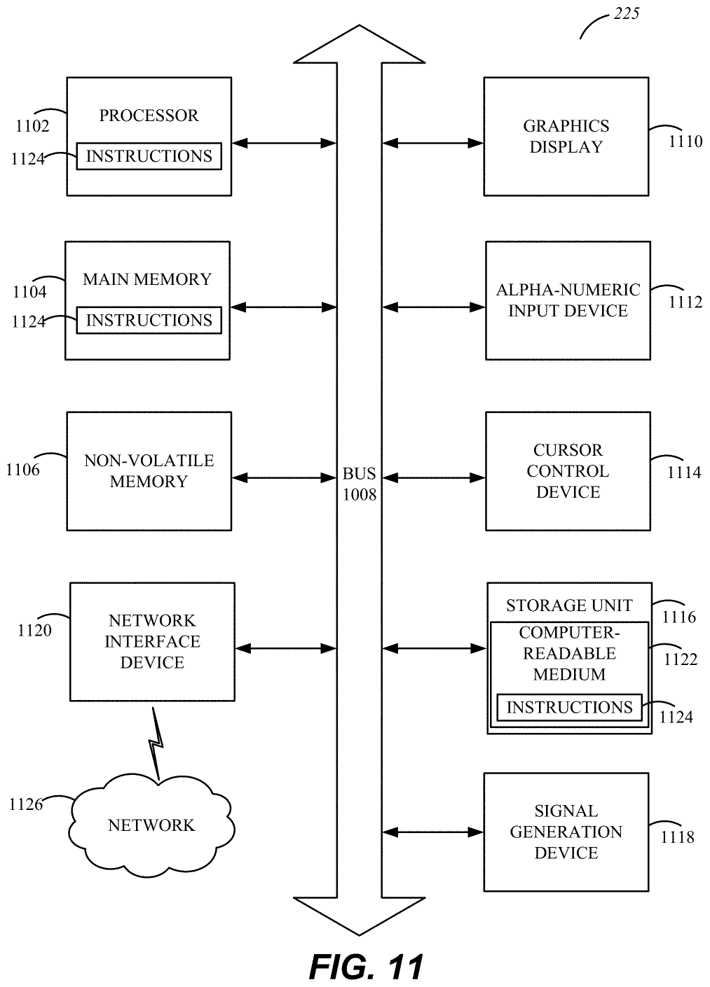

A computing device of the computing server 120 takes the form of software, hardware, or a combination thereof (e.g., a computing machine of FIG. 11). For example, parts of the computing server 120 may be a PC, a tablet PC, a smartphone, an internet of things (IoT) appliance, or any machine capable of executing instructions that specify actions to be taken by that machine. Parts of the server 120 may include one or more processing units (e.g., a central processing unit (CPU), a graphics processing unit (GPU), a digital signal processor (DSP), a controller, a state machine, one or more ASICs, one or more RFICs, or any combination of these) and a memory.

The communications between the client devices 110/111 and the server 120 may be transmitted via a network 140, for example, via the Internet. The network 140 may provide connections to the components of the system through one or more sub-networks, which may include any combination of local area and/or wide area networks, using both wired wireless communication systems. In one embodiment, a network 140 uses standard communications technologies and/or protocols. For example, a network 140 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 140 may be represented using any suitable format, such as hypertext markup language (HTML), extensible markup language (XML), or JSON. In some embodiments, all or some of the communication links of a network 140 may be encrypted using any suitable technique or techniques such as secure sockets layer (SSL), transport layer security (TLS), virtual private networks (VPNs), Internet Protocol security (IPsec), etc. The network 140 may also include links and packet switching networks such as the Internet.

The server 120 may access a database storing food item options, menus, and a library of images that can be dispensed by the sauce dispensing unit 117. Content in the server 120 database may be updated remotely by an administrator of the system. The server 120 may then communicate its new contents via the network 140 enabling automatic updating of all client devices 110 and vending machines 111 remotely.

FIG. 2 is a block diagram illustrating an example of the system architecture of a food preparation unit in accordance with some embodiments. The food prep unit 116 includes food cavities 205, a food dispensing unit 210, a sauce dispensing unit 117, a refrigeration unit 220, and a computing system 225. In some embodiments the components of the food prep unit 116 are housed within the vending machine 111. Other embodiments may have additional components not shown here.

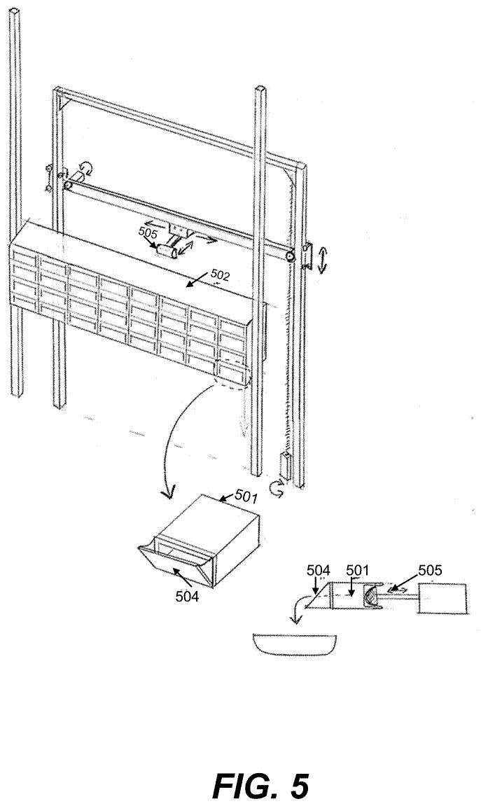

The food cavities 205 are compartments of flexible material, such as silicone. The food cavities are structured for holding food. The food cavities 205 may hold a pre-portioned amount of food for one order in each or a bulk amount of food that is dispensed over several orders. The food cavities 205 are supported by a grid of cubbies such that each cavity is supported and attached to a rigid frame. The food cavities 205 and grid are further described below with reference to FIG. 5.

The food dispensing unit 210 includes a motorized arm that travels along the frame or grid supporting the food cavities 205 and dispenses a portion of food. The food dispensing unit receives instructions from a controller of the vending machine 111 or food prep unit 116 to dispense food items into a bowl as indicated by user input. The food dispensing unit 210 may dispense a portion of food out of the food cavities by operating a motorized punch that pushes on a flexible wall of the food cavity 205, pushing the food item out of an opening on the opposite side of the cavity. The punch navigates to the correct food cavity in the grid with instructions from user input.

The sauce dispensing unit 117 dispenses sauce onto a food surface in the form of an image chosen by a user of the vending machine 111 or client device 110. The sauce dispensing unit 117 receives instructions from a controller of the vending machine 111 or food prep unit 116 to dispense sauce as indicated by user input. According to the instructions, the sauce dispensing unit 117 uses a motor to move a dispensing head and pump sauce out from a cartridge in the form of the chosen image. The sauce dispensing unit 117 is further described below.

The heating unit 215 heats areas of the food prep unit 116. The heating unit 215 heat specific food cavities 205 that hold pre-cooked food to be served hot. The heating unit 215 may also heat nozzles or tubes of the sauce dispensing unit 117 to encourage flow of viscous sauces or heat sauces to be served hot (e.g., cheese sauce). The heating unit 215 may be comprised of heated plates or heating lamps to provide localized heating. The heating unit 215 may also comprise a heated cabinet that encloses portions of the food prep unit 116.

The refrigeration unit 220 provides temperature control to temperature sensitive elements of the food prep unit 116 such as food items in the food cavities 205 and sauces of the sauce dispenser 117. The refrigeration unit 220, in some embodiments, is a refrigerated cabinet that encloses the entire vending machine 111 or the food prep unit 116. In these embodiments, any area of the vending machine 111 or food prep unit 116 for warm or hot food items is insulated to isolate the heated area from refrigeration. In other embodiments, the refrigeration unit 220 may provide localized temperature control such as by running refrigerant through tubes to areas that require cooling. The refrigeration unit 220 may comprise several separate units if the food cavities 205 and sauce dispenser 117 are housed separately.

The computing system 225 may receive information from the application 112/113 based on user input to the client device 110 or vending machine 111. The computing system 225 processes the user input to the applications 112/113 such that it is readable by the components of the food prep unit 116. The computing system 225 is further described below with reference to FIG. 11.

In some embodiments, the food prep unit 116 has additional components such as a lidding unit and order delivery unit. The lidding unit applies a lid or seal to a prepared order once it is complete. The order delivery unit distributes completed orders into specific lockers that can only be opened by the user who made the order.

### Exemplary System Embodiment

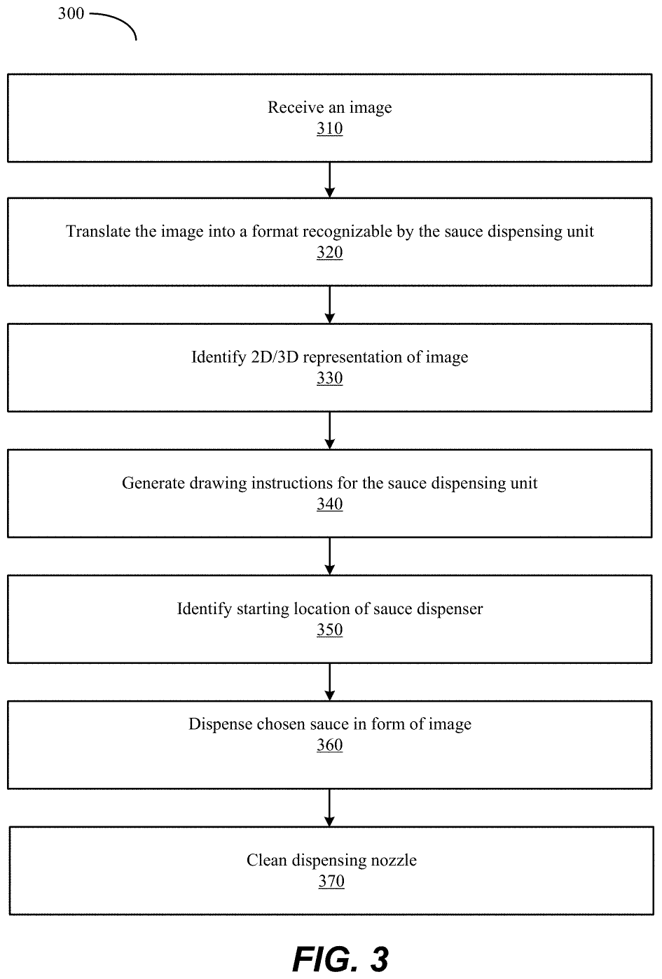

FIG. 3 is a flowchart illustrating an example method of dispensing a sauce design onto food in accordance with some embodiments. The method 300 may have more or less steps depending on the embodiment of the system and the user input. The steps may be comprised of instructions for use a computing system having one or more of the components described with the example computing system of FIG. 11.

A controller of the vending machine 111, such as the application 113, executes program code to receive 310 an image indicating a design that a user has selected to be dispensed onto their food order. As described herein an image may be a drawing, sketch, logo, line art, design, pattern, or other means of visual representation. The image may be a drawing on paper that is scanned or otherwise uploaded to the system 100. The image may also be an electronic file in a variety of formats (.jpg, .jpeg, .png, etc.) from a library of images, uploaded from a user's client device 110, or drawn on the user interface 114/115 of the application 112/113, for example. The content of the image is unrestricted as the controller will later translate it into a version capable of representation in sauce which may be simpler in detail.

The controller executes program code (that is one or more processor executable instructions) to translate 320, the image into a format recognizable or preferred by the sauce dispensing unit 117. For example, a user may choose an image in the .jpg format, but in the example embodiment the sauce dispensing unit 117 may process .png format images, so the image is translated from .jpg to .png. In some embodiments the preferred format will be set by the controller rather than the sauce dispenser 117 if the controller is responsible for the image pre-processing and communicates only instructions to the sauce dispensing unit 117. This step may also be automatically performed by the application 112/113 upon a user choosing the image.

The controller executes program code to identify 330 a 2D or 3D representation of the image. As received, the image may be too complex for successful depiction with sauces. The image in the preferred format is processed to identify the relevant details of the image. For example, the image may be analyzed by the application 112/113 to determine the darkest sections and represent those sections in the instructions. The image may also be compressed to reduce detail such as by taking an average pixel intensity value of a set of pixels of the image and replacing the set of pixels with a single pixel having the average intensity value. As described herein, a 2D representation may be line art using a single layer of sauce, while a 3D representation may involve dispensing multiple layers of sauce to add texture and depth.

The controller executes program code to generate 340 drawing (e.g., dispensing) instructions for the sauce dispenser 117. The instructions may comprise a set of coordinates based on the relevant details in the 2D/3D representation with vectors for traveling between them as well as dispensing characteristics. The coordinates and vectors of the drawing instructions are based on characteristics of the image. For example, two points (e.g., two coordinates) may be placed in a dark area of the image with a vector between the two points indicating a line to be drawn between them. The dispensing characteristics include a selection of sauce(s) to dispense, a dispensing method (e.g., dots of sauce, lines, etc.), a dispensing nozzle, and a dispensing velocity. In one embodiment the sauce dispenser can create low resolution images pixel by pixel by putting a drop of sauce at each location identified by the sauces. In another embodiment the sauce dispenser moves in smooth lines and curves to create line drawings of the identified details of the image.

The sauce dispenser 117 identifies 350 a starting location for the dispensing head to position the nozzle at. The starting location may be an origin point identified in the image during generation of drawing instructions. For example, if the image comprises a line drawing, the controller may identify an origin of the line (e.g., a starting or ending point of the line) and set that origin point as the starting location for the dispensing head in the drawing instructions. In one embodiment, the starting location may be a center point or corner point of the image. The starting location may also be determined based on the topography of the food surface. For example, the sauce dispenser may choose a starting location and orientation of the image such that the image fits on the food surface and is not dispensed onto the sides of the bowl. The starting location may also be dependent upon the shape and size of the food item or the container that is holding the food item. The starting location may be chosen to limit the area that the image occupies. The starting position may be set as coordinate 0,0 with the rest of the coordinate vectors based on the positioning of the chosen starting location.

The sauce dispenser 117 then dispenses the sauce based on the instructions created by the controller. The instructions may further comprise specified pressures at which to pump the sauces to dispense them. Some sauces may be more viscous than others and require an initial acceleration to encourage flow. The instructions may also comprise a type of pump to use based on the sauces chosen in the user input. A thin sauce may be more conducive to dispensing with a peristaltic pump while a thicker sauce may be more conducive to dispensing with a plunger and syringe pump. The motor of the sauce dispenser 117 moves the dispensing head such that the nozzle dispenses the chosen sauces in the correct locations to portray the chosen image.

The sauce dispenser 117 may then clean 370 the dispensing nozzle or nozzles. Sauces left on the dispensing nozzles may harden and clog the nozzle or drip onto other orders, causing unwanted contamination. To prevent this, the sauce dispenser 117 may run the pumps in a reverse direction to create a vacuum and move the sauce from the nozzle toward the cartridge to suck remaining sauce out of the dispensing nozzle. In another embodiment the water, air, or another cleaning fluid is pumped through the dispensing nozzle or nozzles to clear them. This step may occur at a certain frequency (e.g., after 10 orders or a period of time) or only when manually instructed to do so.

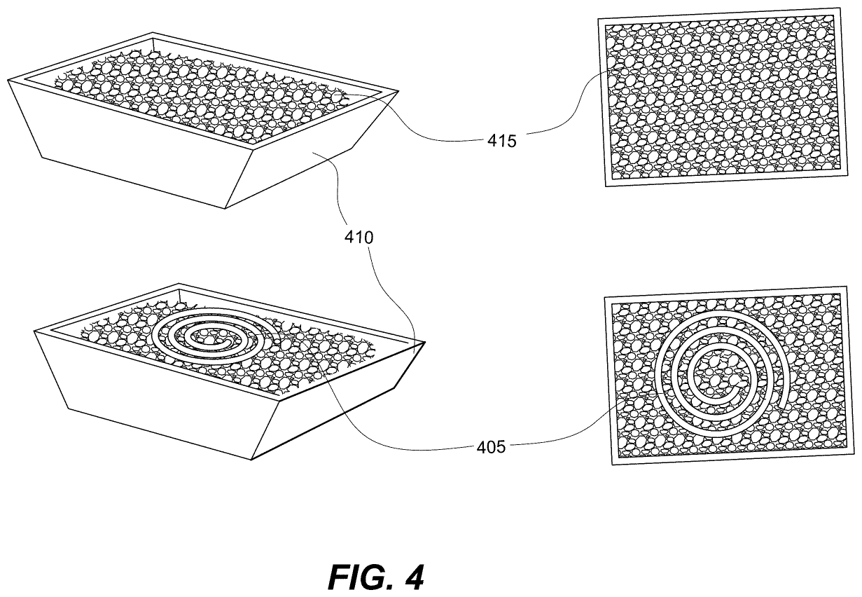

FIG. 4 is an illustration of a bowl of food before and after the dispensing of a sauce design onto it in accordance with some example embodiments. In some embodiments, a bowl 410 is filled with one or more food items by the food prep unit 116 and then travels along a conveyor belt from the food dispensing mechanism (one example is described herein with reference to FIG. 5) to the sauce dispenser 117. When the bowl 410 reaches the sauce dispenser 117 the food surface 415 has no sauce design 405 on it. The food surface 415 may be a bed of rice, pieces of chicken, or other food items. The sauce dispenser 117 is configured to start at a location for the sauce dispensing head 607 based on the topography of the food surface 415 Sauce is dispensed on the food surface 415 in the form of a sauce design 405 chosen by a user. In the shown embodiment of FIG. 4 the sauce design 405 is in the form of a swirl. More complex designs utilizing several sauces and possibly multiple dispensing nozzles are possible in other embodiments.

FIG. 5 is an illustration of a food dispensing unit of a food preparation unit in accordance with some embodiments. The food dispensing unit of FIG. 5 and description below is an exemplary way of dispensing food. However, other methods may be used.

Rather than portioning by hand through the use of a measuring scoop or filling each flexible cavity 501 (e.g., food cavities 205) individually the operator simply has to ensure all cavities are filled to the top. Through use of the portion control positive the operator does not need to change steps for different volumes.

One object of embodiments is to enable accurate pre-portioning and dispensing of food for the purpose of automating the creation of made-to-order dishes. To accomplish this a matrix of thin highly flexible cavities 501 which can vary in material, stiffness, thickness, shape etc. for desired storage conditions, actuation, and content ejection behavior is described. Potential materials for this matrix include silicon, rubber, aluminum, and plastics. These pockets can be put into a matrix of arbitrary size and they can also have heating or cooling units, insulation, and sensor packages embedded into their material. The flexible cavities can be of various dimensions to best suit the need of the material being dispensed and the end use case.

In one example the flexible cavities 501 are a rectangular shape with a depth of 7 inches and a width and height of 2 inches for a total volume of 28 in³. In another example for the dispensing of a different volume of ingredient the depth is shortened to 4 inches and instead of a rectangular opening a circular cavity with a radius of 2 inches is used for a total volume of 50.25 in³. These flexible cavities can be used in the dispensing of ingredient across a wide range of use cases and in a variety of useful physical setups. The size and volume vary in different embodiments.

In one embodiment the matrix of flexible cavities 501 is placed inside of a grid 502 for easy transportation and use. This grid can be made of a flexible or rigid material as well. With a watertight and/or airtight lid 504 and series of nozzles the entire unit can be turned to any desired dispensing angle/orientation with no spilling or leakage. The figures in this application show vertical/horizontal orientations but any orientation could be used. The lid can be held/screwed in place with snap features, screw fasteners, magnets etc.

The grid 502 can be used to keep ingredients hot or cold while in storage. This grid could be an active subsystem with one or both of a heating or cooling system and/or a passive insulated system. In one embodiment, the combination of the flexible cavity 501, grid 502, lid 504, and nozzle is called a food dispensing unit 210 and is shown in FIG. 2. Potential examples of end use cases for this dispenser unit include use in the back of house of a restaurant, customer facing in a dining hall or buffet setting, and in an automated vending capacity which is the use case discussed at length herein.

In an embodiment of a vending machine 111 use case, a customer orders a dish that requires multiple ingredients from one or more of the dispensing units held inside the machine 111. The machine 111 is loaded with one or more dispenser units and dispenses materials from the matrix of flexible cavities 501 within those dispenser units to create the dish for the customer by filling or partially filling a delivery unit.

In one embodiment each matrix within a dispensing unit can include a single type of ingredient and multiple matrices can be used with multiple dispensing units to provide access to dishes that have multiple ingredients. In another embodiment, a single flexible matrix can include multiple ingredients and can be used with one or more dispensing units.

This delivery unit is moved such that it can receive the ingredients dispensed from the correct flexible cavity 501. This flexible cavity is then compressed via a punch 505 such that the ingredient material exits the cavity through a nozzle with the desired velocity and final shape in the target delivery unit. This punch can be used to dispense any amount of the content of the target flexible cavity from 0 to 100%. The punch itself may have heating or cooling options and/or will have dimensional tolerances such that the punch ensures correct portion of cell is emptied upon command. This enables vending of precise amounts of food alone or as part of a larger system or machine 111 via the punch. This punch could be screw driven, spring driven, pneumatic, hydraulic, powered by overactive hamsters, etc.

Retraction of the punch from a given flexible cavity drives retraction of the flexible cavity 501 itself through variety of potential means including but not limited to latching features, magnets, hook and loop, and/or permanent or temporary adhesives.

The nozzles by design prevent all or substantially all dripping or clinging for the given material held in the matrix of flexible cavities 501. The nozzle design can completely change for given materials and can have additional features such as sieves, filters, blades, etc. to aid in dispensing, cleaning, or other purposes. Particular nozzle shapes may be chosen for the desired final presentation of the ingredients within the delivery unit or for the optimal setup for future steps. The nozzles could be active or passive elements and/or contain active elements and/or sensors in their internal structure. For example, embedded sensors could be used to detect the water content of the passing ingredients, their temperature and the ambient temperature and pressure of the machine internals, etc.

When necessary, the machine 111 can move a given dispenser unit so the next row of flexible cavities 501 is closest to the delivery unit, when a previous row of flexible cavities is empty, the movement of the dispenser unit can occur through a variety of techniques, e.g., using hydraulics, lead screw, cam, etc. This enables the clean dispensing of many different ingredients into the delivery unit and for compact storage of ingredients. After the desired ingredients are selected and dispensed the delivery unit is moved to the next step of the dish making process which may include mixing, shaking, reheating, sealing, steaming, braising, broiling, the addition of more ingredients, etc.

When used with a portion control positive, and scraper/pusher filling becomes efficient through a pouring/scraping/shaking action. The portion control positive forces the flexible cavity to compress (much like the punch 505 does during dispensing) to a desired volume. The ingredient is then poured out of a vessel over the open face of the flexible cavity and the flexible cavity is filled. Excess is scraped over the remaining flexible cavities using a scraper/pusher and the process is repeated until the entire matrix of flexible cavities is filled. This can be driven by hand or by machine and is a scalable process that can be grown to accommodate an arbitrary number of dispenser units. A vibration assistant can also be used to aid with ingredient settling.

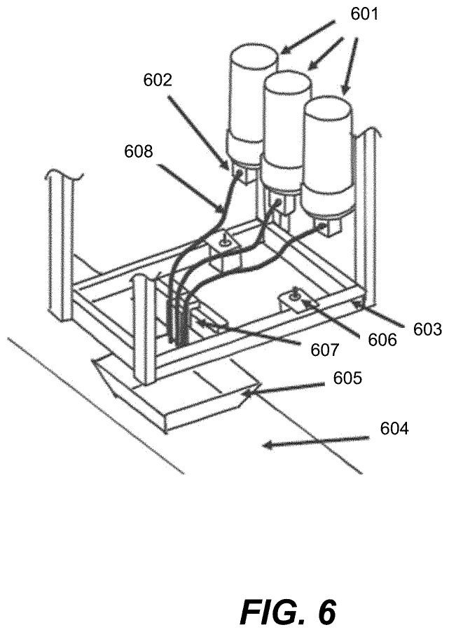

FIG. 6 is an illustration of an example sauce dispensing unit in accordance with some embodiments. The sauce dispensing unit 117 receives instructions from a controller of the food prep unit 116 that comprise a method of dispensing sauce onto a food surface (as shown in FIG. 4) in the form of a chosen image. The sauce dispensing unit 117 may be within the food prep unit 116 with a food dispensing unit 210.

The cartridges 601 are removably coupled to the frame 603 of the unit 117 and hold sauce for dispensing. The cartridges may be removed easily by an operator of the unit for cleaning or refilling of sauces. The shown embodiment of the unit 117 has 3 sauce cartridges, but other embodiments may have more or less. The cartridge 601 may take any form such as a bag, bottle, or box that is capable of holding liquid. The shown embodiment has bottle type cartridges 601.

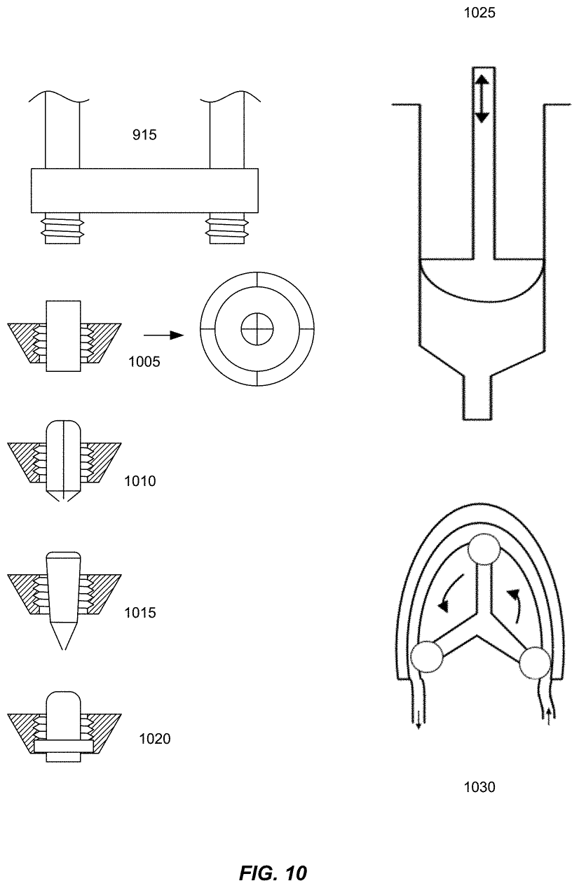

The pumps 602 move the sauce from the cartridges 601 through the tubes 608 for dispensing. Multiple embodiments of the pumps 602 are described in reference to FIG. 10. The tubes 608 (or tubing) may be of variable radii and length depending on the embodiment of the unit 117. The tubes 608 are comprised of flexible and deformable materials such as soft plastics.

The tubes 608 connect the cartridges 601 to the dispensing head 607 such that sauce can be moved from the cartridge to the food surface (e.g., food surface 415). The dispensing head 607 is the potion of the unit 117 that is moved by the motors 606 to dispense sauce in the form of a chosen image. The motors 606 move the dispensing head 607 according to the instructions from the controller. The motors 606 may move the dispensing head via embodiments such as an h-belt drive or delta mechanism that allow for 2D and 3D motion. In some embodiments, multiple dispensing heads 607 and/or motors 606 can be used.

The dispensing head 607 supports the dispensing nozzles that output sauce to the food surface. The sauce is dispensed onto a food surface, the food held by a bowl 605. The bowl may move into position under the unit 117 via a platform 604. The platform 604 includes a conveyor belt or other means of supporting and moving the bowl 605. The platform 604 may move the bowl from the food dispensing unit 220 to the sauce dispensing unit 117 and then to a delivery area for the user to pick up.

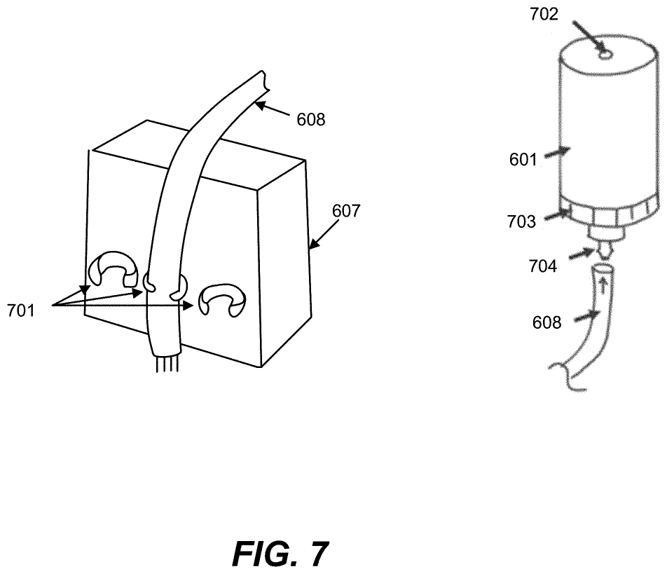

FIG. 7 is an illustration of an example dispensing head and sauce cartridge in accordance with some embodiments. The dispensing head 607 is the portion of the sauce dispensing unit 117 that is moved by the motors 606. The dispending head 607 supports the end of the tubing 608 where sauce is output through a dispensing nozzle. The dispensing head 607 has clamps 701 that fix the tubing 608 to the dispensing head to prevent unwanted movement. The clamps 701 may also be along the frame 603 of the unit 117 to secure the tubing and prevent it from interfering with the movement of the motors 606 and dispensing head 607. The dispensing head 607 may support multiple tubes 608 that transport multiple sauces from the cartridges 601.

The cartridges 601 may have a relief vent 702 to prevent the buildup of excess pressure that could damage the cartridge. The relief vent 702 is a small hole in the top of the cartridge 601 or be a more complex valve. The cartridge 601 additionally includes a cap 703. The cap 703 may be removably screwed onto the cartridge body to seal it. The cap 703 has a cartridge output 704 to enable it to seal to a tube 608. For example, the cartridge output 704 have a barb or flared end such that a deformable material tube can be press fit onto the output 704.

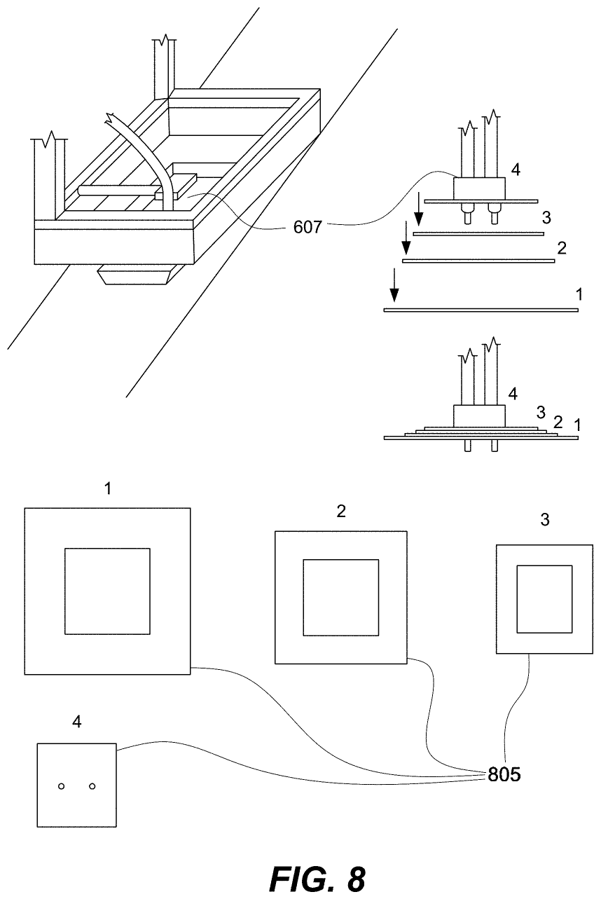

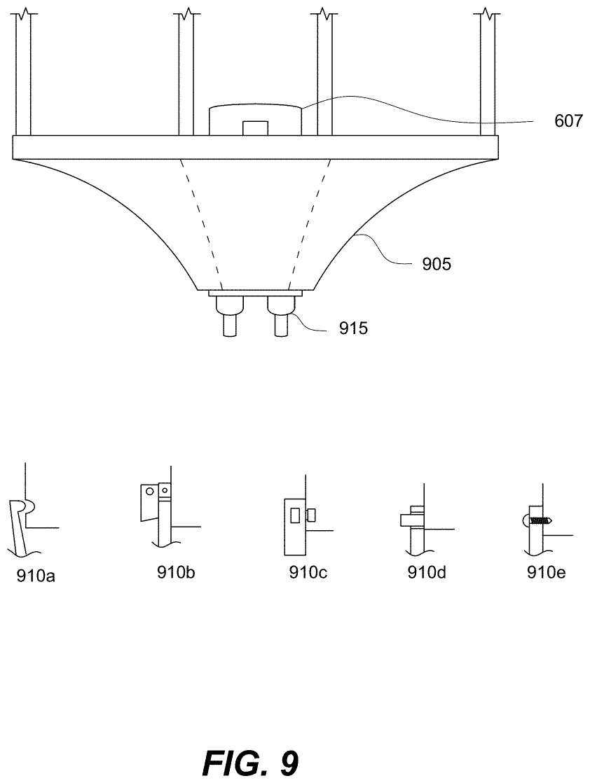

FIG. 8 is an illustration of an example rigid splash guard on the dispensing head in accordance with some embodiments. The splash guards of FIGS. 8 and 9 prevent food and sauces from touching the motor 606, dispensing head 607 or other components of the sauce dispenser 117. Splash back of sauces can cause damage to the sauce dispenser 117 components or cause cross contamination of orders. The rigid splash guard is comprised of stacking platforms 805, for example, illustrated as 1, 2, 3 and 4 in the figure. The smallest of the stacking platforms 805 removably couples to the dispensing nozzles of the dispensing head 607 such that as the motor moves the dispensing head, the stacking platforms 805 slide along each other, following the motion of the dispensing head 607. The largest sliding platform may be removably attached to the frame 603 of the sauce dispenser 117 such that it remains stationary while the smaller platforms move within it.

FIG. 9 is an illustration of an example flexible splash guard on the dispensing head in accordance with some embodiments and several embodiments of attachment methods of a splash guard to the sauce dispensing unit. The flexible splash guard 905 of FIG. 9 prevents splash back hitting the components of the sauce dispenser 117 similarly to the rigid splash guard of FIG. 8. The flexible splash guard is a piece of flexible material such a silicone that is removably coupled to the dispensing head 607 and frame 603 and dispensing nozzle 915. The flexible splash guard moves with the dispensing head 607 as the dispensing nozzles 915 dispense sauce. The flexible splash guard 905 may bend or stretch to accommodate motion of the system without detaching from it.

Items 910 A-E are structures for attachment of the splash guard to the frame, dispensing head, or other components of the sauce dispenser 117. Snap-fit 910A allows the splash guard to removably attach to the unit by fitting within a divot or lip on the unit. The edge of the splash guard may be specially shaped to snap into snap-fit 910A. Locking hinge 910B clips the edge of the splash guard to the unit with arm that rotates on a hinge and locks into a specific position to hold the splash guard. Magnet 910C magnetically attaches the splashguard to the unit by having one pole of a magnetic attached to the unit to attract an opposite pole attached to the splash guard. Post 910D removably attaches the splash guard to the unit through a perforation in the splash guard. The post protrudes from the unit. The perforation is cut to fit the size of the post such that the splash guard can be threaded onto the post 910D for attachment. Screw 910E works similarly to the post 910D, a perforation in the splashguard lines up with a perforation of the unit wherein a screw can be threaded to removably attach the two. Any of the methods of attachment 910 may be used to removably attach the splash guards of FIGS. 8 and 9 to the sauce dispensing unit. Other components of the food prep unit 116 may additionally use these methods.

FIG. 10 is an illustration of several example embodiments of dispensing nozzles and pumps. In some embodiments the sauce outlet is coupled to a dispensing nozzle. In other embodiments, the sauce outlet is bare. In other embodiments, the dispensing nozzle 915 is an attachment that couples to the sauce output end of the tube to direct the sauce in a specific way. For example, a dispensing nozzle 915 may be configured to draw in a specific shape or line thickness similarly to tips used for pastry frosting. Nozzles 1005, 1010, 1015, and 1020 are examples of specialty nozzles that may be used by the sauce dispensing unit 117. The sauce dispensing unit may use multiple nozzles for one order. The unit 117 may have a mechanism for automatic changing of nozzles such as a rotating attachment of the dispensing head that couples a nozzle to the sauce output of the tubing by rotating it into place under the sauce output. In another embodiment the unit 117 may have multiple sauce outputs from multiple tubes, with each output having its own nozzle.

X-seal nozzle 1005 has a tip covered with a film. The film is perforated in the form of an X. The film may be made of flexible and/or elastic materials such as silicone. The film of the x-seal nozzle 1005 opens along the perforation as sauce applies outward pressure. When the sauce is no longer being pumps and is no longer pushing the perforation open, the film closes. The seal of the x-seal nozzle 1005 may prevent dripping and contamination of a sauce.

Dual input nozzle 1010 may be coupled to two sauce outputs and dispenses them through the same nozzle tip. The dual input nozzle 1010 allows for mixing of sauces into a single dispensed line. For example, if a user orders sriracha mayo on their food, the dual input nozzle 1010 can receive an output of mayo and an output of sriracha and dispense them together to mix them.

Fine tip nozzle 1015 has a narrow opening which allows it to dispense fine lines or points of sauce. The fine tip nozzle 1015 may be used to dispense details of the chosen image.

Temperature controlled nozzle 1020 has a temperature-controlled ring inside that can chill or heat sauces as they pass through. The ring may be chilled such as by the refrigeration unit 220 or heated by the heating unit 215. Chilling the ring may help thin or watery sauces be dispensed cleanly while heating the ring may help thick or viscous sauces be dispensed effectively without clogging the nozzle.

The sauce dispensing unit 117 may also employ multiple kinds of pumps 602 to move sauce from the cartridges 601 to the dispensing nozzle 915. The pump 602 (or pumps) of the sauce dispensing unit 117 apply pressure to the sauce through a variety of means to move the sauce as described by instructions from a controller of the food prep unit 116. The instructions may also describe which kind of pump 602 to use for a specific order or sauce if the unit 117 has multiple available pumps that are automatically interchangeable. Different pumps may be preferred based on the type of sauce being dispensed. Two pump embodiments are described below, however, other pump embodiments can be used by the unit 117.

One embodiment of a pump used by the sauce dispenser 117 is the plunger pump 1025. The plunger pump 1025 works similarly to a syringe in which a plunger is pressed into the cartridge to increase pressure and push sauce out, or the plunger may be pulled up and away from the cartridge to bring sauce into the cartridge. The plunger pump 1025 may be preferable for use with thick sauces that need high force or pressure to begin to move.

Another embodiment of a pump of the sauce dispenser 117 is the peristaltic pump 1030. The peristaltic pump 1030 works by rotating an arm that presses on the tubing, forcing the sauce within the tubing to move in the direction of the rotating arm. The peristaltic pump works with deformable tubing materials such as soft plastics or silicone. The rotating arm deforms the tube as it presses upon it. The deformation of the tube pushes the sauce in to direction of the arm's rotation.

### Example Computing Machine

FIG. 11 is a block diagram illustrating an example architecture of a computing device, in accordance with some embodiments. The computing device (or computer) is capable of reading instructions from a computer-readable medium and executing them in a processor (or controller). The computing device may include a controller, such as the controller discussed with reference to FIG. 3, or a processor that is configured to execute program code such as lines of codes comprising instructions for the controller or processor. A computer described herein may include a single computing machine shown in FIG. 11, a virtual machine, a distributed computing system that includes multiples nodes of computing machines shown in FIG. 11, or any other suitable arrangement of computing devices.

By way of example, FIG. 11 shows a diagrammatic representation of a computing machine in the example form of a computer system 225 within which instructions 1124 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 11 may correspond to any software, hardware, or combined components shown in FIG. 1, including but not limited to, the user device 111, the computing server 120, and various engines, modules, interfaces, terminals, computing nodes and machines. While FIG. 11 shows various hardware and software elements, each of the components described in FIG. 1 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1124 that specify actions to be taken by that machine. Further, while only a single machine is illustrated, the term “machine” and “computer” may also be taken to include any collection of machines that individually or jointly execute instructions 1124 to perform any one or more of the methodologies discussed herein.

The example computer system 225 includes one or more processors 1102 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 225 may also include a memory 1104 that store computer code including instructions 1124 that may cause the processors 1102 to perform certain actions when the instructions are executed, directly or indirectly by the processors 1102. Instructions can be any directions, commands, or orders that may be stored in different forms, such as equipment-readable instructions, programming instructions including source code, and other communication signals and orders. Instructions may be used in a general sense and are not limited to machine-readable codes. The processors 1102 may include one or more multiply-accumulate units (MAC units) that are used to perform computations of one or more processes described herein.

One and more methods described herein improve the operation speed of the processors 1102 and reduces the space required for the memory 1104. For example, the various processes described herein reduce the complexity of the computation of the processors 1102 by applying one or more novel techniques that simplify the steps in analyzing data and generating results of the processors 1102. The algorithms described herein also reduces the size of the models and datasets to reduce the storage space requirement for memory 1104.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 225 may include a main memory 1104, and a static memory 1106, which are configured to communicate with each other via a bus 1108. The computer system 225 may further include a graphics display unit 1111 (e.g., a plasma display panel (PDP), a liquid crystal display (LCD), a projector, or a cathode ray tube (CRT)). The graphics display unit 1111, controlled by the processors 1102, displays a graphical user interface (GUI) to display one or more results and data generated by the processes described herein. The computer system 225 may also include alphanumeric input device 1112 (e.g., a keyboard), a cursor control device 1114 (e.g., a mouse, a trackball, a joystick, a motion sensor, or other pointing instrument), a storage unit 1116 (a hard drive, a solid state drive, a hybrid drive, a memory disk, etc.), a signal generation device 1118 (e.g., a speaker), and a network interface device 1120, which also are configured to communicate via the bus 1108.

The storage unit 1116 includes a computer-readable medium 1122 on which is stored instructions 1124 embodying any one or more of the methodologies or functions described herein. The instructions 1124 may also reside, completely or at least partially, within the main memory 1104 or within the processor 1102 (e.g., within a processor's cache memory) during execution thereof by the computer system 225, the main memory 1104 and the processor 1102 also constituting computer-readable media. The instructions 1124 may be transmitted or received over a network 1126 via the network interface device 1120.

While computer-readable medium 1122 is shown in an example embodiment to be a single medium, the term “computer-readable medium” should be taken to include a single medium or multiple media (e.g., a centralized or distributed database, or associated caches and servers) able to store instructions (e.g., instructions 1124). The computer-readable medium may include any medium that is capable of storing instructions (e.g., instructions 1124) for execution by the processors (e.g., processors 1102) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

In various embodiments, a non-transitory computer readable medium that is configured to store instructions may be used. The instructions, when executed by one or more processors, cause the one or more processors to perform steps described in the above computer-implemented processes or described in any embodiments of this disclosure. In various embodiments, a system may include one or more processors and a storage medium that is configured to store instructions. The instructions, when executed by one or more processors, cause the one or more processors to perform steps described in the above computer-implemented processes or described in any embodiments of this disclosure.

### Additional Considerations

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “includes,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. A method comprising:
receiving, at a food preparation unit, an image selected by a user;
generating, based on the image, drawing instructions for dispensing sauce onto a food item prepared by the food preparation unit in the form of the image, the instructions comprising coordinate vectors and dispensing characteristics;
identifying a starting location of a dispensing nozzle; and
dispensing the sauce onto the food item by pumping sauce from a cartridge to the dispensing nozzle, the dispensing nozzle coupled to an actuator that moves according to the instructions.

2. The method of claim 1, further comprising:
cleaning the dispensing nozzle by pumping the sauce in a reverse direction, from the dispensing nozzle toward the cartridge.

3. The method of claim 1, further comprising:
cleaning the dispensing nozzle by pumping water or cleaning fluid through the dispensing nozzle.

4. The method of claim 1, wherein the dispensing characteristics comprise one or more of a selection of a sauce to dispense, a dispensing method, a dispensing nozzle, and a dispensing velocity.

5. The method of claim 1, wherein identifying a starting location is based on one or more of a shape, size, or topology of the food item or a container of the food item.

6. The method of claim 1, further comprising:
displaying, at a food preparation unit, a plurality of images for selection by a user.

7. A food preparation system comprising:
a controller configured to execute program code to:
receive an image;
generate, based on the image, drawing instructions for dispensing sauce onto a food item prepared by the food preparation system in the form of the image, the instructions comprising coordinate vectors and dispensing characteristics;
identify a starting location of the dispensing nozzles; and
a sauce dispensing unit configured to dispense the sauce from the dispensing nozzle in the form of the image, the sauce dispensing unit comprising:
a cartridge configured to hold one or more sauces;
a tube having two ends, a first end removably attached to a cartridge and a second end removably attached to a dispensing nozzle, each tube configured to deliver sauce from the cartridge to the dispensing nozzle;
a dispensing head supporting the tube;
a dispensing nozzles removably attached to the dispensing head;
a motor actuating movement of the dispensing head based on the coordinate vectors of the instructions;
a pump actuating the movement of sauce from the cartridges to the dispensing nozzles through the tubes based on the dispensing characteristics; and
a temperature control unit.

8. The system of claim 7, wherein the sauce dispensing unit is further configured to clean the dispensing nozzle by pumping the sauce in a reverse direction, from the dispensing nozzle toward the cartridge.

9. The system of claim 7, wherein the sauce dispensing unit is further configured to clean the dispensing nozzle by pumping water or cleaning fluid through the dispensing nozzle.

10. The system of claim 7, wherein the temperature control unit is configured to heat or cool sauces in the cartridge, tube, or dispensing nozzle based on the instructions.

11. The system of claim 7, wherein the dispensing characteristics comprise one or more of a selection of a sauce to dispense, a dispensing method, a dispensing nozzle, and a dispensing velocity.

12. The system of claim 7 wherein identifying a starting location is based on one or more of a shape, size, or topology of the food item or a container of the food item.

13. The system of claim 7, wherein the controller is further configured to:
display a plurality of images for selection by a user.

14. A non-transitory computer readable storage medium comprising stored instructions, the instructions when executed causes the processor to:
receive, at a food preparation unit, an image selected by a user;
generate, based on the image, instructions to draw using a sauce onto a food item prepared by the food preparation unit in the form of the image, the instructions further comprising instructions to generate coordinate vectors and dispensing characteristics;
determine a starting location of a dispensing nozzle; and
dispense the sauce onto the food item by pumping sauce from a cartridge to the dispensing nozzle, the dispensing nozzle coupled to an actuator that moves according to the generated instructions.

15. The non-transitory computer readable storage medium of claim 14, further comprising instructions that when executed causes the processor to:
clean the dispensing nozzle by pumping the sauce in a reverse direction, from the dispensing nozzle toward the cartridge.

16. The non-transitory computer readable storage medium of claim 14, further comprising instructions that when executed causes the processor to:
clean the dispensing nozzle by pumping water or cleaning fluid through the dispensing nozzle.

17. The non-transitory computer readable storage medium of claim 14, wherein the dispensing characteristics comprise one or more of a selection of a sauce to dispense, a dispensing method, a dispensing nozzle, and a dispensing velocity.

18. The non-transitory computer readable storage medium of claim 14, wherein the instructions to determine a start location is based on one or more of a shape, size, or topology of the food item or a container of the food item.
